(19) United States
(12) Patent Application Publication
(10) Pub. No.: US 2014/0365487 A1
(43) Pub. Date: Dec. 11, 2014

(54) METHOD OF REMOTELY CRITIQUING AN IMAGE AND SOFTWARE APPLICATION THEREFORE

(71) Applicants: Brian J. Ditthardt, Lake Placid, FL (US); Michael R. Miller, Boca Raton, FL (US)

(72) Inventors: Brian J. Ditthardt, Lake Placid, FL (US); Michael R. Miller, Boca Raton, FL (US)

(21) Appl. No.: 14/298,579

(22) Filed: Jun. 6, 2014

Related U.S. Application Data
(60) Provisional application No. 61/831,970, filed on Jun. 6, 2013.

(51) Int. Cl. G06F 17/30

(52) U.S. Cl. CPC G06F 17/30247
USPC 707/736

(57) ABSTRACT

A method of remotely critiquing an image is disclosed that includes receiving an electronic image at a portable electronic device of a user, wherein the electronic image visually depicting at least one of plurality of steps physically performed by the user. The method also includes then transmitting the electronic image, over a network, to a server having at least one database communicatively coupled thereto and annotating the electronic image with at least one reviewing indicia concerning the at least one of plurality of steps physically performed by the user to create an annotated electronic image, the at least one reviewing indicia caused by a second user. The process also includes transmitting the annotated electronic image to the user for review.

### CROSS-REFERENCE TO RELATED APPLICATION

This application claims priority to U.S. Provisional Patent Application No. 61/831,970 filed Jun. 6, 2013, the entirety of which is incorporated by reference.

### FIELD OF THE INVENTION

The present invention relates generally to method of providing comments or indicia to an image, and more particularly relates to a software application providing users the ability to transfer an image relating to conduct performed by a user to a reviewing entity to provide comments or critiques to that image and send that image back to the user.

### BACKGROUND OF THE INVENTION

There are many known devices and methods available on the market to help critique conduct of a user that is memorialized on a visual medium. These known devices and methods, however, require the reviewing entity (hereinafter “reviewer”) to be present when providing the critique and while the conduct is occurring in real-time. This creates a problem where the reviewer either does not recall every detail of the conduct he or she observed—thereby providing an inadequate critique of that conduct—or managing the time constraints of the reviewer. Alternatively, those devices and methods require the user who provides the visual medium to be reviewed (hereinafter “user”) to wait a significant period of time before the critique from the reviewer can be received.

Many of those known devices and methods also do not capture the capture the spirit and authenticity of the reviewer as if the reviewer was actually present and viewing the conduct of the user to be reviewed.

Therefore, a need exists to overcome the problems with the prior art as discussed above.

### SUMMARY OF THE INVENTION

The invention provides a method of remotely critiquing an image and software application therefore that overcomes the hereinafore-mentioned disadvantages of the heretofore-known devices and methods of this general type and that captures the spirit and authenticity of a reviewer as if they were present and visually seeing the conduct as it was occurring in real time. Capturing the elements of the conduct in form that is easily and effectively capable of being reviewed and commented on ensures the authenticity of the person annotating and commenting on the content.

The present invention provides a simple interface and integration of onboard input tools on a portable electronic device, e.g., iPhone or iPad, which simplifies the whole critiquing experience. The invention solves many of the problems prevalent in the art by enabling a reviewer to view a document or multimedia file, and make graphical drawings on it, typing comments, or recording audio comments and video footage of the reviewer him or herself. The claimed invention differs from what currently exists as the present invention captures the spirit and emotion of the reviewer, and records all of those elements and emotion on the received image from the user. Then, the modified image of the user is compressed with all of those elements provided by the reviewer and sent back to the user for review or to be shared by others.

Although the invention is illustrated and described herein as embodied in a method of remotely critiquing an image and software application therefore, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. The terms “program,” “software application,” and the like as used herein, are defined as a sequence of instructions designed for execution on a computer system. A “program,” “computer program,” or “software application” may include a subroutine, a function, a procedure, an object method, an object implementation, an executable application, an applet, a servlet, a source code, an object code, a shared library/dynamic load library and/or other sequence of instructions designed for execution on a computer system.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a block diagram of an exemplary data processing network used in conjunction with an embodiment of the present invention;

FIG. 2 is an image depicting an image being captured on an electronic device used in conjunction with the present invention;

FIG. 3 is a screen shot of the present invention embodied in a software application that enables a reviewer to annotate the image captured by the electronic in accordance with an embodiment of the present invention;

FIG. 4 is a block diagram depicting a multi-layered image that is compressed into a single layered image viewed by the user; and

FIG. 5-8 depict screen shots of the present invention embodied in a software application, specifically showing the application accessible to reviewer/user, operable to have the image modified by the reviewer, and having the multiple videos/data accessible and organized on the server for access by the reviewer and/or administrator in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

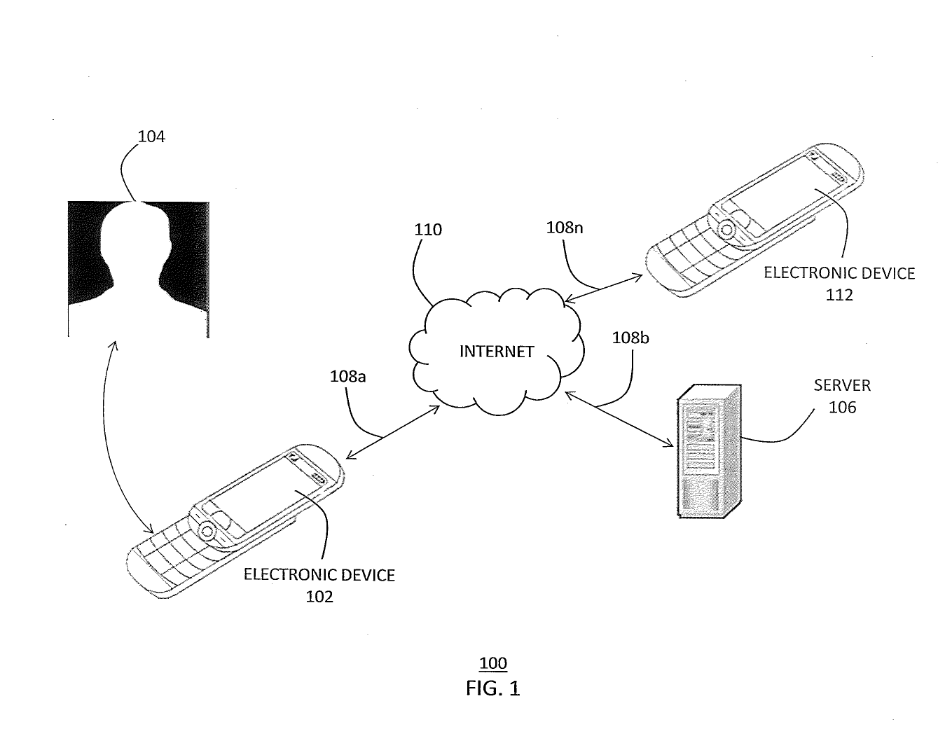

The present invention provides a novel and efficient synchronized method of remotely critiquing an image. Referring now to FIG. 1, one schematic of a data network 100 carrying out one embodiment of the present invention is shown. FIG. 1 shows several advantageous features of the present invention, but, as will be described below, the invention can be provided in several shapes, sizes, combinations of features and components, and varying numbers and functions of the components.

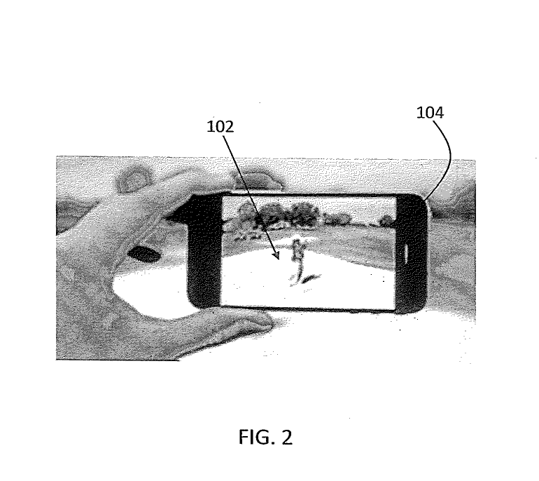

In the depicted example, a method of remotely critiquing an image shown and first starts with receiving an electronic image 104 at a portable electronic device 102 of a user. The electronic image 104, or an image represented as two dimensional array of brightness values for pixels, visually depicts at least one of plurality of steps physically performed by the user. FIG. 2 depicts an exemplary image 200 being captured by a camera of an exemplary electronic device 102. The network 100 includes the computing device 102, a server 106, and a second electronic device 112, e.g., iPad, having a display and operable to be communicatively coupled to the network 100. The image 104 is in a computer-readable medium such as .gif, .jpeg, .png, and the like. In other embodiments, the electronic image visually depicts a plurality of steps physically performed by the user, e.g., a video.

In the depicted example, network 100 can include the Internet 110, which represents a worldwide collection of networks and gateways that use the TCP/IP suite of protocols to communicate with one another. At the heart of the Internet 110 is a backbone of high-speed data communication lines between major nodes or host computers, consisting of thousands of commercial, government, educational and other computer systems that route data and messages. Of course, network 100 also may be implemented as a number of different types of networks, such as for example, an Intranet, a local area network (LAN), or a wide area network (WAN). FIG. 1 is intended as an example, and not as an architectural limitation for the present invention.

The network 100 may include additional servers and other devices and entities not shown. In the depicted example, the computing device 102, which is represented as a mobile computing device, communicates with the server 106 or the second electronic device 112 to transmit the image 104 to the secondary device 112 and/or server 106. Said another way, after the image 104 is received, the image may be transmitted, over the network 100, to a server 106 having at least one database (not shown) communicatively coupled thereto. In one embodiments, the electronic image 104 is stored on a user account stored on the at least one database on the server 106 or the secondary device 112.

In other embodiments, the computing device 102 may communicate with the server 106 or other device coupled to the network 100 to receive an image of the user or to implement the steps of the present invention with an image located on another device coupled to the network 100. This type of data exchange may occur through the Internet 110, or another wireless or wired data exchange method, e.g., Bluetooth, radio frequency identification (RFID), or near field communications (NFC). Moreover, any of the depicted network entities, in addition to communicating with each other over the network 100, are, in some embodiments, also able to communicate in a peer-to-peer relationship using wired or wireless links. In embodiments of the present invention, various computing entities located on the network 100 may perform all, or some, of the above-described steps of the present invention represented in FIG. 1 or otherwise disclosed herein.

The network 100 includes connections 108a-n, which are the medium used to provide communication links between various devices and computers, or computing devices, connected together within the network 100. The connections 108a-n may be wired or wireless connections. A few exemplary wired connections are cable, phone line, and fiber optic. Exemplary wireless connections include radio frequency (RF) and infrared radiation (IR) transmission. Many other wired and wireless connections are known in the art and can be used with the present invention.

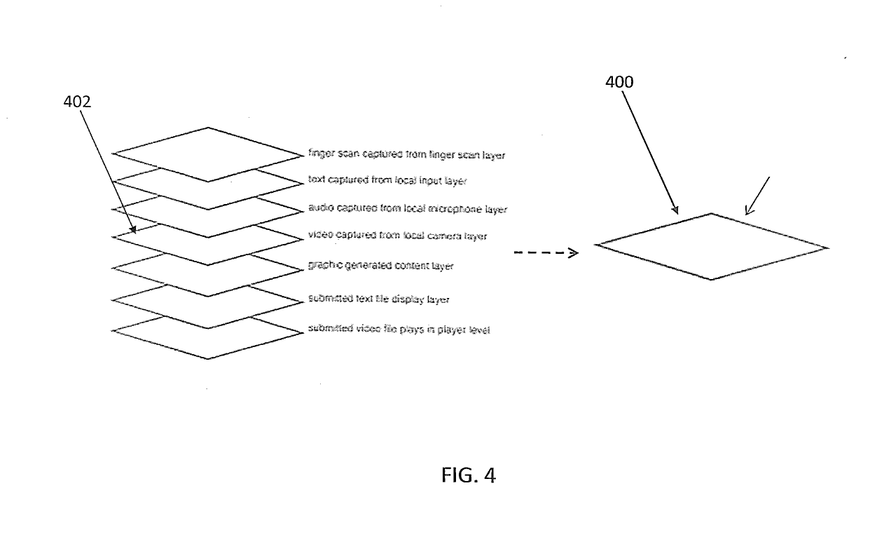

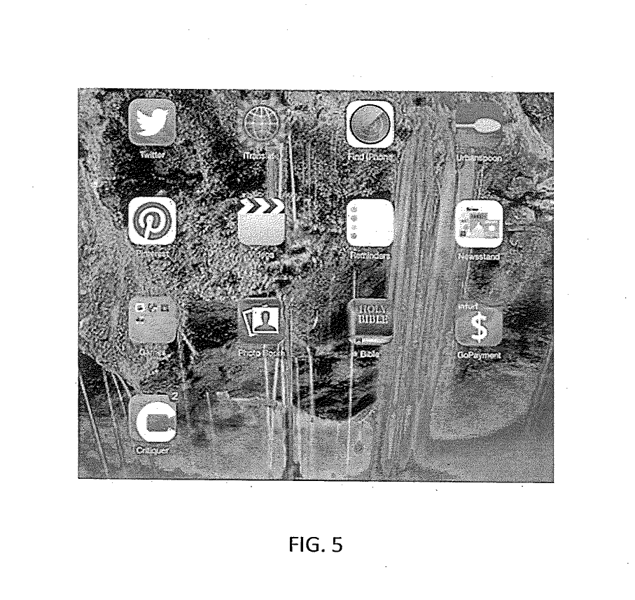

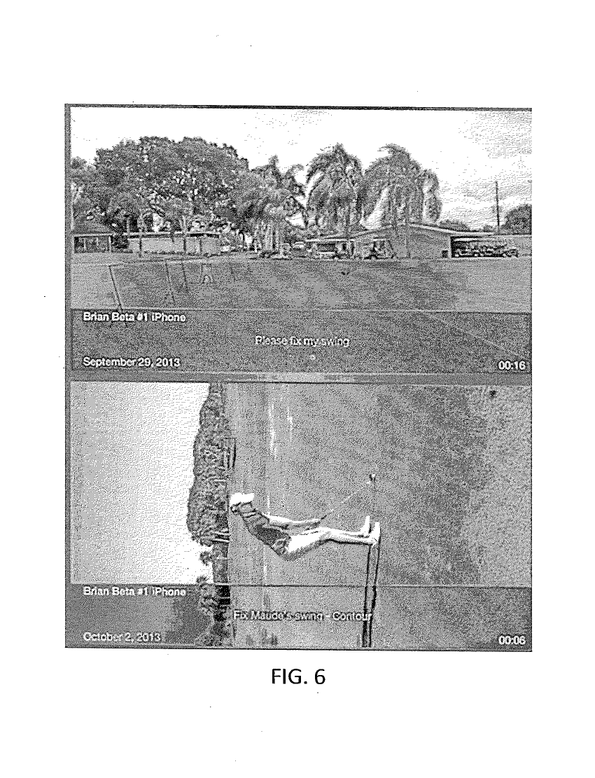

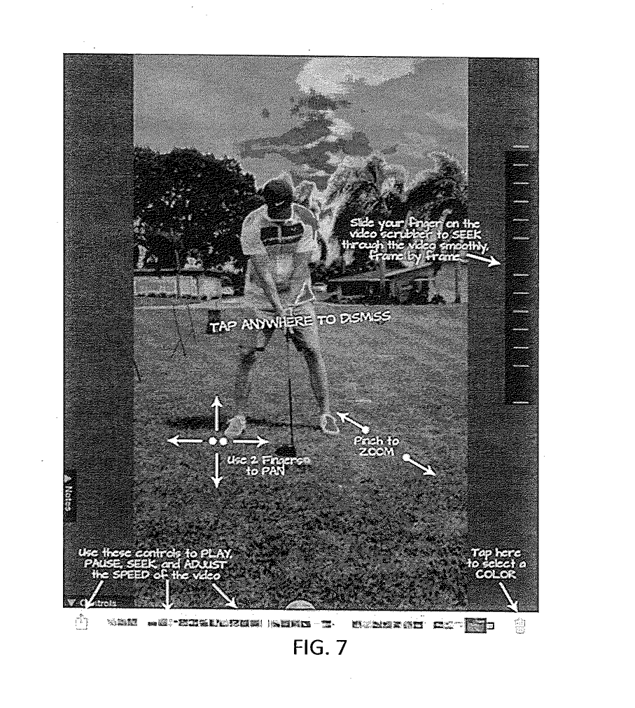

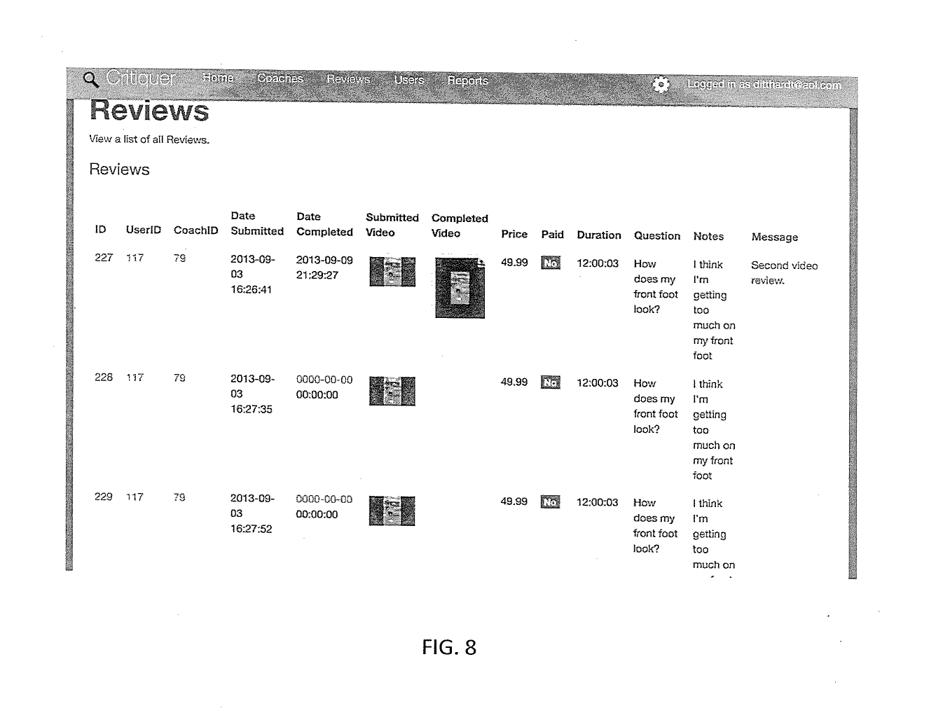

With reference to FIGS. 1, 3 and 4, the image, e.g., file, to be reviewed is uploaded into the platform that distributes that file to the intended person or entity that will review the file, e.g., server 106. The file may then be opened with the software application, wherein the secondary user (“reviewer”) interacts with the file while their feedback and interactions are recorded. Said another way, the reviewer annotates the electronic image 104 with at least one reviewing indicia concerning the at least one of plurality of steps physically performed by the user to create an annotated electronic image 400. The at least one reviewing indicia is caused by a second user operating the electronic device 112. As shown in FIG. 4, the software program merges those data layers 402 into a new composite file 400. The composite file 400 is then sent back into a distribution platform, which based on platform rules, the final composite file is delivered to the identified target. The identified target is, typically, the user operating the electronic device 102. Said another way, the annotated image is transmitted to the user for review.

Upon delivery, the person requesting the review, or critique is charged to their credit card. The server 106 receives the submitted file database stores and processes how that file is directed to proper reviewer and/or user account. Once in that account, the software application accesses that file. Using the software application, the reviewer's comments and feedback are recorded and compressed into a composite file, wherein that composite file is then directed to the intended receiver or target and billing takes place.

The system relies on the components processing and directing files to intended audiences, and devices. Once received by the software application, the software application creates a new file containing the original file plus the recorded media layers. Those layers are then compressed into a composite file, which is then sent back into the system to be billed and delivered to the end-user.

Logic is based on relationships set up by users submitting files and reviewing files. Those of skill in the art in database design would begin developing a data management system that collects submitted document files, and directs them to destinations that match the requested path. Included in that path is a software application found on a device, e.g., iPhone, iPad, or similar device. The software application is designed to display the source file/image 104, plus record layers of additional input over that image 104. This input may include written lectures, drawings, audio, and video. Once collected the app is designed to compress all of those components into 1 new file 400 containing those elements. That resulting file is then sent back into the database system which based on the rules associated with that file, are delivered to the target.

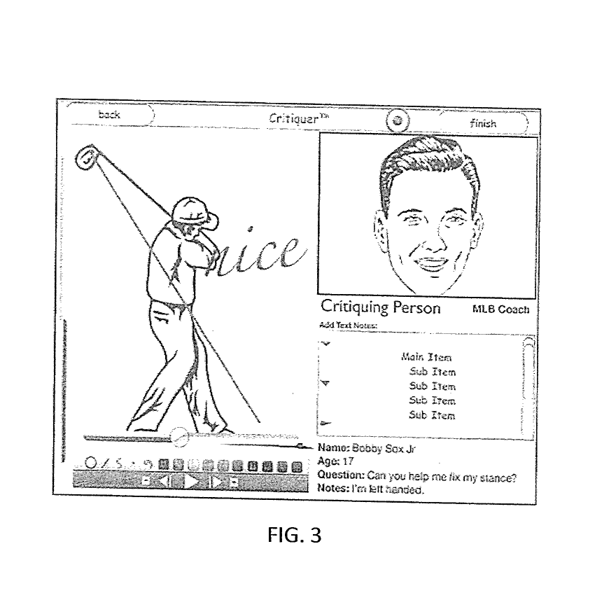

In one exemplary embodiment of the present invention a person, “user,” utilizes the present invention to analyze his or her golf swing. This can be seen in FIG. 3, wherein a person who plays golf could use the invention to video record their play. That file is then submitted to the software application operated by a golf coach that then watches the submitted video. While watching the video, all of their expressions and interactions are collected and recorded and layered over the original image 104 to generate an annotated image. Said another way, those components are compressed into a new composite video which is sent back to the golf player to get feedback and coaching input from someone that was not at the place it was filmed. In addition to sports that same situation can occur in reviewing medical files, documents or other.

What is claimed is:

1. A method of remotely critiquing an image, series of images, animation, or video, the method comprising the steps of:
receiving an electronic image at a portable electronic device of a user, the electronic image visually depicting at least one of plurality of steps physically performed by the user;
transmitting the electronic image, over a network, to a server having at least one database communicatively coupled thereto;
annotating the electronic image with at least one reviewing indicia concerning the at least one of plurality of steps physically performed by the user to create an annotated electronic image, the at least one reviewing indicia caused by a second user; and
transmitting the annotated electronic image to the user for review.

2. The method according to claim 1, further comprising:
storing the electronic image on a user account stored on the at least one database.

3. The method according to claim 1, wherein:
the electronic image visually depicts the plurality of steps physically performed by the user.
